(19) United States
(12) Patent Application Publication
(10) Pub. No.: US 2006/0222925 A1
(43) Pub. Date: Oct. 5, 2006

(54) Fuel cell having gas/liquid isolated structure

(76) Inventors: Hsi-Ming Shu, Taipei (TW); Feng-Yi Deng, Taipei (TW); Tsang-Ming Chang, Taipei (TW); Chen Hung Lin, Tainan (TW); Jing-Tang Jan, Taipei (TW); Yean-Der Kuan, Taichung (TW)

Correspondence Address: G .LINK Co.,LTD, 3550 Bell Road,, MINOOKA, IL, 60447, US

(21) Appl. No.: 11/094,728

(22) Filed: Mar. 31, 2005

(51) Int. Cl. H01M 8/02

(52) U.S. Cl. 429/34; 429/38

(57) ABSTRACT

The present invention is related to a fuel cell having gas/liquid isolated structure, comprising a fuel cell core component and an isolating layer component. The fuel cell core component is used to produce electricity by electro-chemical reaction. The isolating layer is a porous film layer with gas ventilation but with liquid isolation placed inside the fuel cell and is used to isolate the liquid of fuel cell core component in an electro-chemical reaction and the liquid produced after the electrochemical reaction by the isolating layer, and is also used to ventilate the gas of fuel cell core component in electro-chemical reaction and the gas produced after electro-chemical reaction through the isolating layer so as to achieve the functions of water-proof, anti-leakage and liquid-leak prevention.

### FIELD OF THE INVENTION

The present invention is related to a fuel cell, especially to utilize the porous film layer material with gas ventilation but with liquid isolation to form an isolating layer so as to make the fuel cell achieve water-proof and liquid-leak prevention and also exhaust the gas produced after the fuel cell reaction.

### BACKGROUND OF THE INVENTION

The used fuel cell is to respectively provide hydrogen-included fuel and oxygen-included fuel on both sides of a proton exchange membrane to form a current loop after oxidation-reduction reaction for the demand of offering power. The reactants required for this kind of fuel cell include liquid fuel like methanol fuel, and the major products after reaction are the water and carbon dioxide so as to make the fuel cell prevent such liquids to leak outward to the working electronic devices, and it also needs to exhaust produced gas to maintain the stable air composition and constant pressure inside the fuel cell. The used fuel cell usually utilizes a mechanism structural design like pressure-release valve to solve this problem; however, this kind of design always has a directional constraint in usage and influences on the structural design of fuel cell.

The inventor investigates the disadvantages of the used fuel cell and desires to improve and invent a fuel cell having a gas/liquid isolated structure.

### SUMMARY OF THE INVENTION

The main object of the present invention is to provide a fuel cell having the functions of water-proof, liquid-leak prevention and exhausting the produced gas.

To achieve the above object, the present invention provides a fuel cell having gas/liquid isolated structure, comprising: a fuel cell core component used to produce electricity by an electro-chemical reaction; an isolating layer which is a porous film layer with gas ventilation but liquid isolation placed inside the fuel cell and used to isolate the liquid of the fuel cell core component in electro-chemical reaction and the liquid produced after electrochemical reaction by the isolating layer and also used to ventilate the gas of fuel cell core component in electro-chemical reaction and the gas produced after electro-chemical reaction through the isolating layer so as to achieve the functions of water-proof, anti-leakage and liquid-leak prevention.

### BRIEF DESCRIPTION OF DRAWINGS

The above objects and advantages of the present invention will become more apparent with reference to the appended drawings wherein:

FIG. 1 shows the structural view of the present invented fuel cell having gas/liquid isolated structure;

FIG. 2 shows the cross-sectional view of the fuel cell embodiment according to the structure of FIG. 1;

FIG. 3A shows the embodiment of the present invented isolating layer placed upon the top surface of the anode fuel supply unit;

FIG. 3B shows the embodiment of the present invented isolating layer placed upon the bottom surface of the anode fuel supply unit;

FIG. 3C shows the embodiment of the present invented isolating layer placed around the peripheral sides of the anode fuel supply unit;

FIG. 4A shows the embodiment of the present invented isolating layer placed upon the top surface of the cathode fuel supply unit;

FIG. 4B shows the embodiment of the present invented isolating layer placed upon the bottom surface of the cathode fuel supply unit;

FIG. 4C shows the embodiment of the present invented isolating layer placed around the peripheral sides of the cathode fuel supply unit; and

FIG. 5 shows the isolating layers are respectively placed upon the top surface of the anode current collection layer and the bottom surface of the current collection layer according to the spirit of the present invention.

### DETAILED DESCRIPTION OF THE INVENTION

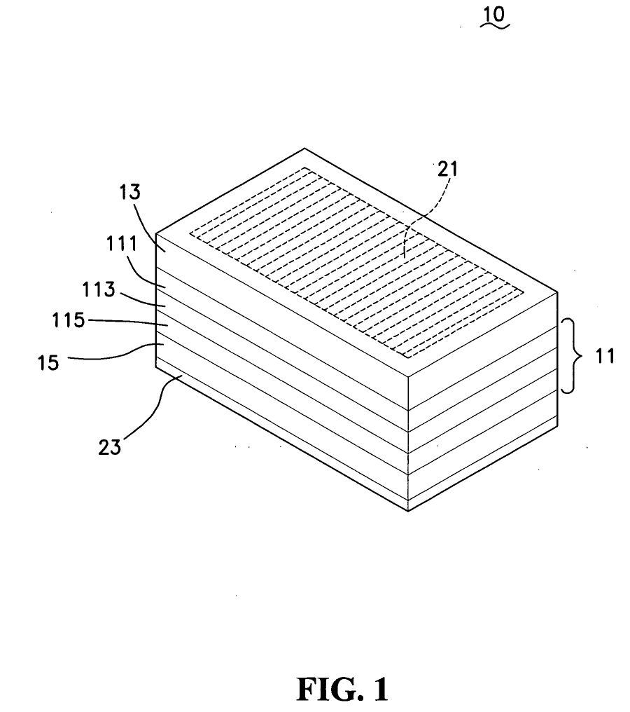

FIG. 1 shows the structural view of the present invented fuel cell having gas/liquid isolated structure. The present invented fuel cell 10 having gas/liquid isolated structure is mainly to place isolating layer 21, 23 inside the fuel cell 10 to prevent fuel liquid transmission but still ventilate the gas so as to achieve liquid-leak prevention and the produced gas ventilation after the fuel cell reaction to maintain a constant pressure inside the fuel cell 10. The present invented fuel cell 10 mainly comprises fuel cell core component 11, anode fuel supply unit 13 and cathode fuel supply unit 15. The fuel cell core component 11 is mainly composed of anode current collection layer 111, membrane electrode assembly layer 113 and cathode current collection layer 115. In FIG. 1, anode current collection layer 111 and cathode current collection layer 115 are respectively piled upon both sides of the layer 113, some fuel cell units 113a of the membrane electrode assembly layer 113 precede electro-chemical reaction and respectively collect currents on anode current collection layer 111 and cathode current collection layer 115. Anode fuel supply unit 13 is connected to the anode side of the fuel cell core component 11 to provide and guide the anode fuel to the anodes of fuel cell core component 11. Cathode fuel supply unit 15 is connected to the cathode side of fuel cell core component 11 to provide and guide the cathode fuel to the cathodes of fuel cell core component 11. Isolating layers 21, 23 are placed in anode fuel supply unit 13 or cathode fuel supply unit 15, and also the isolating layers 21, 23 are capable of using the porous film layer with gas ventilation but liquid isolation to make fuel cell 10 achieve the functions of water-proof, anti-leakage and liquid-leak prevention by the physical property of such a porous film layer.

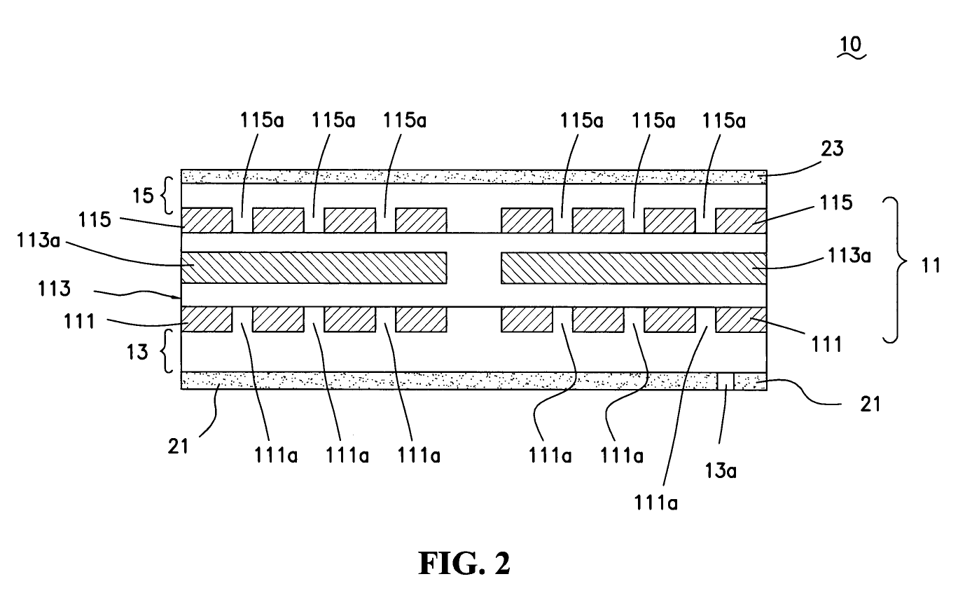

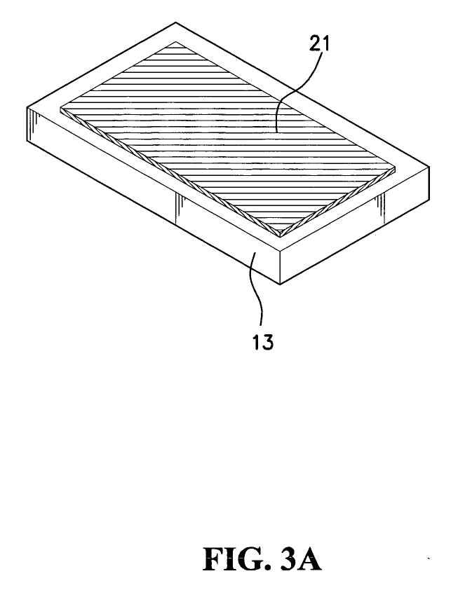

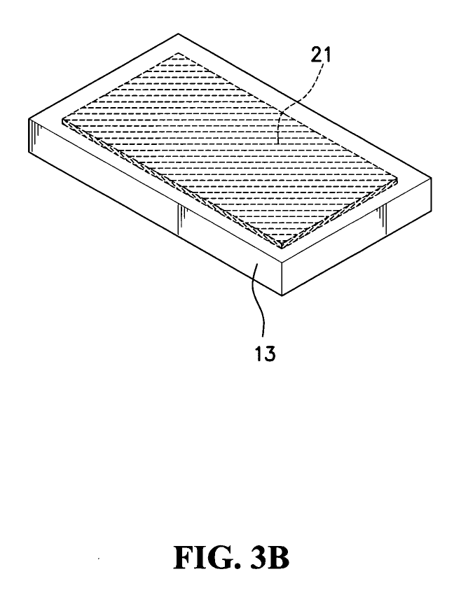

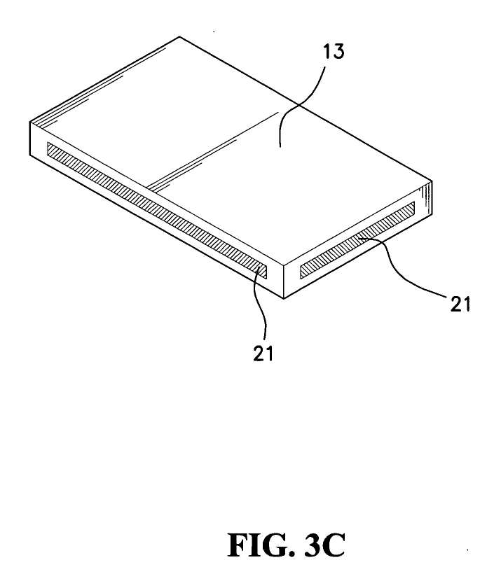

FIG. 2 shows the cross-sectional view of the fuel cell embodiment according to the structure of FIG. 1. In FIG. 2 of the direct methanol fuel cell 10, the concrete object of anode fuel supply unit 13 is capable of being a flow field component, for instance, a flow field component constructed by the fuel trough and the fuel flow channel, anode fuel supply unit 13 injects the methanol solution of anode fuel from injection inlet 13a and the injected methanol solution of anode fuel flows through the holes 11a to sufficiently supply to the anode of every fuel cell unit 113a. Isolating layer 21 is placed upon anode fuel supply unit 13, the placed position is capable of the top surface, bottom surface or peripheral sides of anode fuel supply unit 13, referring to the embodiments shown in FIG. 3A to FIG. 3C of the isolating layer placed upon the anode fuel supply unit. The methanol solution flowing around is capable of being isolated to leak outward the outside of anode fuel supply unit 13 by the physical property of the porous film layer of isolating layer 21. Meanwhile, the gas of carbon dioxide produced around the anode terminal of fuel cell unit 113a by chemical reaction is able to pass isolating layer 21 to exhaust outward through the gas outlet (not shown in the figure).

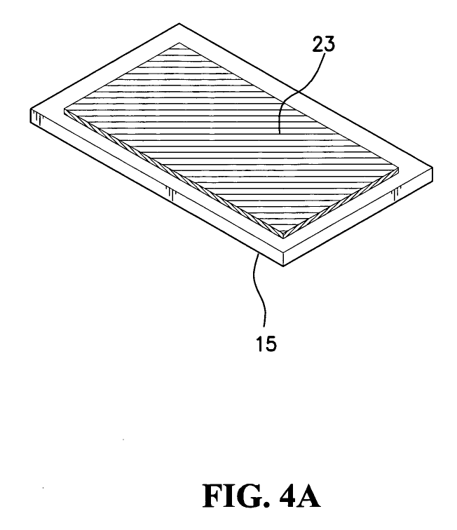

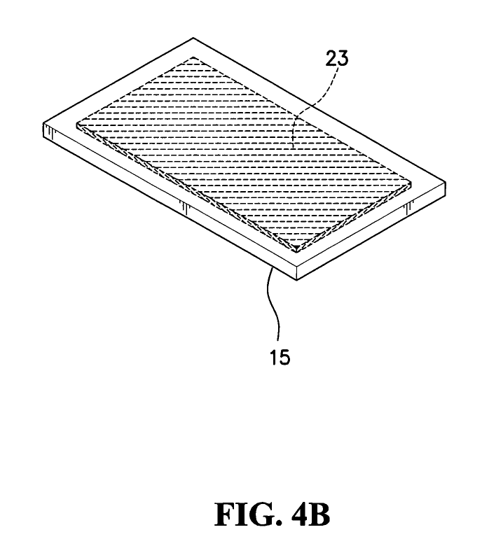

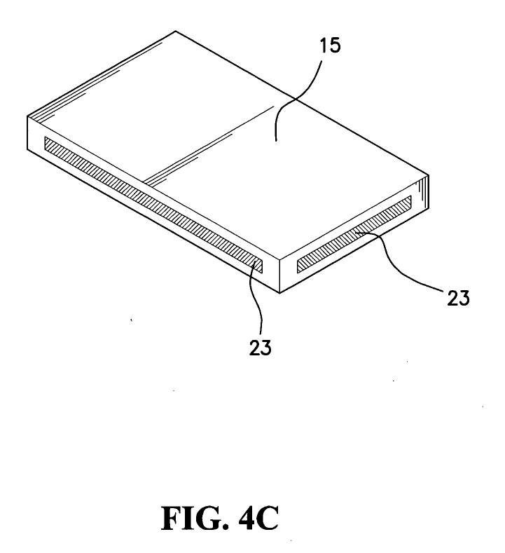

In FIG. 2 of direct methanol fuel cell 10, isolating layer 23 is placed upon cathode fuel supply unit 15, the placed position is capable of the top surface, bottom surface or peripheral sides of cathode fuel supply unit 15, referring to the embodiments shown in FIG. 4A to FIG. 4C of the isolating layer placed upon the cathode fuel supply unit. The external air (or the oxygen) is able to pass isolating layer 23 through the holes 115a to arrive at the cathode of every fuel cell unit 113a by the physical property of the porous film layer of isolating layer 23. Meanwhile, the water produced by the cathode terminal of the fuel cell unit 113a by chemical reaction is able to be isolated by isolating layer 23 to leak outside of cathode fuel supply unit 15 and then exhaust from the water outlet (not shown in the figure).

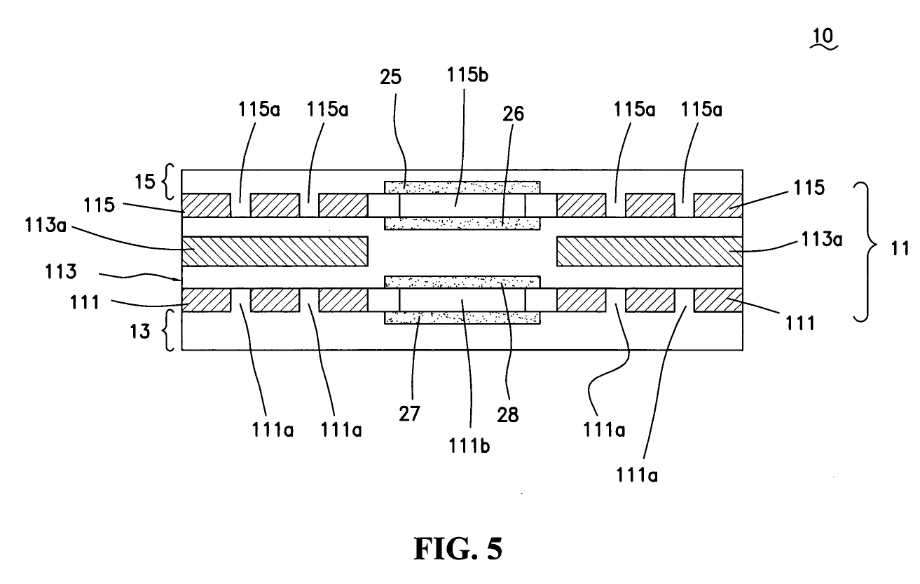

FIG. 5 shows the isolating layers are respectively placed upon the top surface of the anode current collection layer and the bottom surface of the current collection layer according to the spirit of the present invention. According to the spirit of the present invention, the present invention is capable of placing isolating layer 25 on the top surface of cathode current collection layer 115 or placing isolating layer 26 on the bottom surface of cathode current collection layer 115, similarly, placing isolating layer 27 on the bottom surface of anode current collection layer 111 or placing isolating layer 28 on the top surface of the anode current collection layer 111. The gas like carbon dioxide produced after electrochemical reaction of the layer 113 is able to pass through the holes 111b and isolating layers 27, 28 to flow outward. The liquid like the water produced after electrochemical reaction of the layer 113 fails to exhaust from the holes 115b because of possibly being isolated by isolating layers 25, 26.

All the porous materials with gas ventilation but liquid isolation are possibly utilized for the present invention like Poly tetrofluoro ethylene (PTFE) as the material used for the isolating layer in the present invention. Furthermore, the pressure both inside and outside the present invented fuel cell 10 is able to keep constant because of the ventilating effect of the isolating layer.

According to the spirit of the present invention, the present invented isolating layer placing at the above disclosed position is also possibly placed at other position inside fuel cell 10 like the gas exhaust outlet to prevent the external liquid flowing inside from the gas exhaust outlet to damage fuel cell 10.

The present invented fuel cell having gas/liquid isolated structure has the following advantages:
1. The gas/liquid isolated structure of the present invented fuel cell utilizing the porous material with gas ventilation but liquid isolation to form the isolating layer is easily achieving the purposes of preventing the leakage of the fuel liquid of the fuel cell, exhausting the gas produced by chemical reaction and also entering the external air;
2. The gas/liquid isolated structure of the present invented fuel cell having gas ventilation but liquid isolation is able to prevent the leakage of the fuel liquid to practically implement the fuel cell equipped inside the electronic device as the internal power;
3. The gas/liquid isolated structure of the present invented fuel cell having gas ventilation but liquid isolation is able to exhaust produced gas in any equipped angle and never concerns the liquid leakage in any direction so as not to be influenced by the equipped direction for the usage of the fuel cell to make the fuel cell usage more popular; and
4. By using the gas/liquid isolated structure of the present invented fuel cell to utilize a film isolating layer is easily achieving a gas ventilating but liquid isolating structure under the original designed structure and does not increase much volume for the fuel cell.

Although the present invention has been disclosed one embodiment as the above, it does not imply to limit the present invention, any person who is skilled the art could make any change or modification within the spirit and scope of the present invention, however, it belongs to the scope of the present invention, the protective scope of the present invention is defined by the following claims.

What is claimed is:

1. A fuel cell having gas/liquid isolated structure, comprising:
a fuel cell core component, used to produce electricity by electrochemical reaction;
an isolating layer, being a porous film layer with gas ventilation but liquid isolation placed inside the fuel cell and used to isolate the liquid of fuel cell core component in electrochemical reaction and the liquid produced after electrochemical reaction by the isolating layer, and also used to ventilate the gas of fuel cell core component in electro-chemical reaction and the gas produced after electrochemical reaction through the isolating layer so as to achieve the functions of water-proof, anti-leakage and liquid-leak prevention.

2. The fuel cell of claim 1, wherein the fuel cell core component comprises an anode current collection layer, a membrane electrode assembly layer and a cathode current collection layer.

3. The fuel cell of claim 2, wherein the isolating layer is placed on the top surface of the anode current collection layer.

4. The fuel cell of claim 2, wherein the isolating layer is placed on the bottom surface of the anode current collection layer.

5. The fuel cell of claim 2, wherein the isolating layer is placed on the top surface of the cathode current collection layer.

6. The fuel cell of claim 2, wherein the isolating layer is placed on the bottom surface of the cathode current collection layer.

7. The fuel cell of claim 1, further comprising:
an anode fuel supply unit connecting to the fuel cell core component, used to provide and guide the anode fuel to the anodes of the fuel cell core component;
a cathode fuel supply unit connecting to the fuel cell core component, used to provide and guide the cathode fuel to the cathodes of the fuel cell core component

8. The fuel cell of claim 7, wherein the isolating layer is placed on the top surface of the anode fuel supply unit.

9. The fuel cell of claim 7, wherein the isolating layer is placed on the bottom surface of the anode fuel supply unit.

10. The fuel cell of claim 7, wherein the isolating layer is placed on the peripheral sides of the anode fuel supply unit.

11. The fuel cell of claim 7, wherein the isolating layer is placed on the top surface of the cathode fuel supply unit.

12. The fuel cell of claim 7, wherein the isolating layer is placed on the bottom surface of the cathode fuel supply unit.

13. The fuel cell of claim 7, wherein the isolating layer is placed on the peripheral sides of the cathode fuel supply unit.

14. The fuel cell of claim 1, wherein the fuel cell is a direct methanol fuel cell.

15. The fuel cell of claim 14, wherein the isolating layer is used to pass the external air through the isolating layer and prevent the water produced by the reaction in the direct methanol fuel cell from leaking outward the outside of the fuel cell.

16. The fuel cell of claim 14, wherein the isolating layer is used to pass the gas of carbon dioxide produced by the reaction and prevent the methanol solution from leaking outward the outside of the fuel cell by the isolating layer.

17. The fuel cell of claim 1, wherein the isolating layer is Poly tetrofluoro ethylene (PTFE)
